(19) United States
(12) Patent Application Publication
(10) Pub. No.: US 2021/0029491 A1
(43) Pub. Date: Jan. 28, 2021

(54) System and Method for Tracking a User's Course by Comparing Geolocation Data from a Known Course

(71) Applicant: LapKing Holdings, LLC, Lewisville, TX (US)

(72) Inventors: Vincent G. Monteleone, Aubrey, TX (US); Jerry Lee Chappell, JR., Lewisville, TX (US)

(21) Appl. No.: 17/068,527

(22) Filed: Oct. 12, 2020

Related U.S. Application Data
(63) Continuation-in-part of application No. 16/594,769, filed on Oct. 7, 2019, now Pat. No. 10,805,763.
Application No. 16/594,769 is a continuation of application No. 16/195,131, filed on Nov. 19, 2018, now Pat. No. 10,440,507.
Application No. 16/195,131 is a continuation of application No. 15/844,872, filed on Dec. 18, 2017, now Pat. No. 10,136,253.
(60) Provisional application No. 63/030,857, filed on May 27, 2020.

(51) Int. Cl. H04W 4/021; A63K 3/00; G01S 5/00; G01S 19/42; H04W 4/02; G07C 1/22; H04W 4/30

(52) U.S. Cl. CPC H04W 4/021; A63K 3/00; G01S 5/0009; H04W 4/30; H04W 4/025; G07C 1/22; H04W 4/027; G01S 19/42

(57) ABSTRACT

A computer-implemented method and system for tracking a user's course using geolocation data is provided. The method comprises obtaining a set of predetermined GPS locations representing a course; tracking movements of a user using a GPS controller; authenticating the movements of the user against the set of predetermined GPS locations while the client terminal is within a predetermined distance of at least one of the set of predetermined GPS locations; and presenting consolidated timing information about the user's movements along the set of predetermined GPS locations. The system comprises a central processing server in communication with a computer network and configured to obtain information from a central database; and one or more client terminals in communication with the central processing server via the computer network, and configured to provide a graphical user interface for user interaction with the central processing server.

### CROSS-REFERENCE TO RELATED APPLICATIONS

This application claims the benefit of U.S. Provisional Application Serial No. 63/030,857 filed May 27, 2020.

This application is also a Continuation in Part of U.S. patent application Ser. No. 16/594,769, filed Oct. 7, 2019, which is a Continuation of U.S. patent application Ser. No. 16/195,131 filed Nov. 19, 2018 which is a Continuation of U.S. patent application Ser. No. 15/844,872 filed Dec. 18, 2017, and issued as U.S. Pat. No. 10,136,253 on Nov. 20, 2018, all of which are incorporated herein by reference in their entirety.

### BACKGROUND OF INVENTION

### 1. Field of Invention

The present invention relates to a system and a method related to obtaining, processing and/or displaying GPS data from a vehicle and authenticating the vehicle's course by processing data from the vehicle and comparing to geolocation data for a known course. The invention further relates to the transfer of data from a GPS receiver to a computing device for processing and displaying to users of the computing device.

### 2. Description of Related Art including Information Disclosed under 37 C.F.R. 1.97 and 1.98

This section is intended to provide a background or context. The description herein may include concepts that could be pursued but are not necessarily ones that have been previously conceived or pursued. Therefore, unless otherwise indicated herein, what is described in this section is not prior art in this application and is not admitted to be prior art by inclusion in this section.

People who navigate on a course are often interested in tracking information about lap times on the course and comparing with others on the course. This can be done using stopwatches or the like. The problem with using a stopwatch is that it's cumbersome, difficult to compare times quickly or during competition, and subject to course cutting that may result in inaccurate comparisons. Moreover, current GPS processing systems do not allow users to easily compare data and do not provide for a means to authenticate or confirm that the course was followed by the user. Current GPS processing systems require a separate GPS unit in order to get an accurate and precise calculation of users' geographic location.

What is needed is for a method and system that tracks user geolocation data around a course and compares that data to a known location data in a way that allows users to compare their times among other users of the course on their mobile computing devices or other computing devices.

### BRIEF SUMMARY

In certain example embodiments described, methods and system support tracking a user's course using geolocation data. The disclosed technique and related system comprise obtaining, from a central database, a set of predetermined GPS locations representing a course; tracking movements of a user using a GPS controller, where tracking the movements of the user further comprises timing the movements of the user; authenticating the movements of the user against the set of predetermined GPS locations while the client terminal is within a predetermined distance of at least one of the set of predetermined GPS locations; determining whether successful authentication of the user's movements is greater than a predetermined success threshold; and upon determining whether successful authentication of the user's movements is greater than a predetermined success threshold, storing timing information in the central database, and retrieving and presenting the timing information on the client terminal.

Other embodiments are also disclosed herein. Another embodiment provides that the predetermined distance is 8 meters. Yet another embodiment further comprises aggregating the consolidated timing information of a plurality of users into an ordered list and presenting the ordered list to the plurality of users on the graphical user interface on the client terminal. The successful authentication can comprise authentication of a predetermined number of the set of predetermined GPS locations.

The disclosed principles can also be provided through a system for tracking a vehicle's course using geolocation data. The system comprises a central processing server in communication with a computer network and configured to obtain information from a central database; one or more client terminals in communication with the central processing server via the computer network, and configured to provide a graphical user interface for user interaction with the central processing server. The one or more client terminals of the system are configured to obtain, from the central database, a set of predetermined GPS locations representing a course; track movements of a user using a GPS controller, where tracking the movements of the user further comprises timing the movements of the user; authenticate the movements of the user against the set of predetermined GPS locations while the client terminal is within a predetermined distance of at least one of the set of predetermined GPS locations; and upon determining whether successful authentication of the user's movements is greater than a predetermined success threshold, storing timing information in the central database, and retrieving and presenting the timing information on the client terminal.

In another embodiment, the tracking system provides that the predetermined distance is 8 meters. The one or more client terminals can be further configured to aggregate the consolidated timing information of a plurality of users into an ordered list and present the ordered list to the plurality of users. Also, successful authentication can comprise authentication of a predetermined number of the set of predetermined location positions based on the sequential order.

In yet another exemplary embodiment, a course generation system used with a tracking system for tracking a user's course using geolocation data is disclosed The course generation system can comprise a central processing server in communication with a computer network and configured to obtain information from a central database; and a mobile device in communication with the central processing server via the computer network, comprises a geolocation controller, and is configured to provide a graphical user interface for user interaction with the central processing server. The mobile device can be configured to track a course using the geolocation controller; record geolocation positions of the course to a set of predetermined geolocation positions; and store the set of predetermined geolocation positions to the central database. The set of predetermined geolocation is then accessed by one or more client terminals of the tracking system, and then the one or more client terminals tracks movements of users of the one or more client terminals, authenticates the movements of the users against the set of predetermined geolocation positions while the one or more client terminals is within a predetermined distance of at least one of the set of predetermined geolocation positions; and upon determining whether successful authentication of the users' movements is greater than a predetermined success threshold, stores timing information in the central database.

### BRIEF DESCRIPTION OF THE DRAWINGS

The present invention will be more fully understood by reference to the following detailed description of the preferred embodiments of the present invention when read in conjunction with the accompanying drawings, wherein:

FIG. 1 illustrates a block diagram of a user tracking system.

FIG. 2 is an illustration of a set of geolocation positions on a course.

FIG. 3 illustrates a screenshot of a graphical user interface, in accordance with the disclosed principles, for a course with information about the best lap times for the course, and for a user to start tracking his movements along the course.

FIG. 4 illustrates a screenshot of a graphical user interface demonstrating geographically finding a nearby established course.

FIG. 5 illustrates a screenshot of a graphical user interface for activating tracking of the user's movements on a course, where the interface also shows lap or stage times on the course of the current session.

FIG. 6 illustrates a screenshot of a graphical user interface for posting a user's best lap or stage time after the user completed a lap or stage and the lap or stage time for the lap or stage is the user's best time so far.

FIG. 7 illustrates a screenshot of a graphical user interface demonstrating groups of riders currently logging laps or stages along the course.

FIG. 8 illustrates a screenshot of a graphical user interface for a user profile.

FIG. 9 illustrates a screenshot of a graphical user interface of a trophy available to the user with the best lap or stage time at a course.

FIG. 10 illustrates a screenshot of a graphical user interface demonstrating the user tracking system utilized with racing competitions and events, and presenting information about the racing competition and events with a user's information.

FIG. 11 is another block diagram of a user tracking system.

FIG. 12 is an illustration of a course with defined windows, areas, or buckets and the locations of a user's recorded geolocational movements along the course.

FIG. 13 illustrates a data table of predetermined coordinates, and a user's recorded geolocational movements.

FIG. 14 is a flowchart illustration of a method of analyzing a user's geolocational movements against a set of predetermined coordinates.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION

The disclosed principles provide a number of innovations, including novel systems and method for facilitating a unique user tracking platform. The system and method can be used for racing, such as running, speed walking, skiing, snowboarding, vehicles, cars, boats, sailing, surfing, biking, off-road vehicles, Baja racing, motocross, karting, snow-cross, UTV racing, and ATV racing, or for training purposes. The platform disclosed herein may also be used for any other type of racing activity or contest, or any other type of timed contest. A detailed discussion of the disclosed platform is provided below; however, it should be understood that the embodiments or examples described herein are only exemplary and do not limit the broader scope of the disclosed principles.

Generally speaking, the disclosed user tracking technique facilitated by the disclosed principles involves acquiring a set of geolocation positions that represent a course, and using the predetermined set of geolocation positions as a backdrop against tracking the geolocation of a user along the course. These geolocation positions can be GPS locations or GPS coordinates expressed using latitude and longitude, and are generated by course proprietors, which is discussed below. The user's geolocation and time at the geolocation is recorded and tracked, and this tracked information is authenticated against the set of geolocation positions to ensure that the user is moving to locations as prescribed by the set of geolocation positions. The tracked information needs a successful authentication greater than a predetermined success threshold, which can be called a success rate, and this is further disclosed below. Then, the user tracking technique presents timing information about the user's movements along the set of predetermined location positions, so that each user using the user tracking technique is able to see his or her lap or stage time when he or she finishes a lap or stage of the set of geolocation positions.

A lap as described herein is one circuit of a track or other predetermined closed course, and when used with the exemplary technique, a user completes a lap when his tracked movements successfully matches, within a predetermined tolerance based on the predetermined success threshold, the set of predetermined geolocation positions, which is further disclosed below. As such, the disclosed technique allows users' course and/or lap time to be tracked on the predetermined course, such as an existing racetrack.

A stage as described herein is one portion of a track or other predetermined course, and when used with the exemplary technique, a user completes a stage when his tracked movements successfully matches, within a predetermined tolerance based on the predetermined success threshold, the set of predetermined geolocation positions for that portion of a predetermined track or course, which is further disclosed below. As such, the disclosed technique allows users' course and/or lap time to be tracked on the predetermined course, such as an existing racetrack or race path.

Established courses as described herein are courses where course proprietors have created a set of geolocation positions that represents their courses. The exemplary user tracking technique allows course proprietors to create the set of geolocation positions for their courses, and the geolocation positions can be edited or modified as needed to provide maximum accuracy and entertainment for patrons of courses. However, the technique can be used for any course and is not limited to race tracks, trails, or paths. As mentioned earlier, the set of geolocation positions represents a course and the set of geolocation positions corresponds to and map to physical geolocation positions on the course.

A course proprietor is herein used to describe administrators of the disclosed technique and any system or method using any embodiments or techniques disclosed herein. A course proprietor may also be the owner of a course.

To establish a course, proprietors can use the disclosed technique to track their movements on the course and starting with a start point, the technique records a geolocation position every 16 meters. Once the proprietor completes the course at a finish point, the set of geolocation positions is created and uploaded to a database.

In another embodiment, once the set of geolocation positions for a course are created and set down by the course proprietor, patrons of a course can use the disclosed exemplary technique to keep track of and log their lap or stage times. As an incentive to use the disclosed exemplary technique, lap or stage times for others users can be aggregated and consolidated for presentation to all users, and a marker for the best lap or stage time for a particular course is awarded to the user with the fastest lap time. Calculation of lap or stage time is disclosed further below.

In an exemplary embodiment, a user can manually activate the disclosed exemplary technique to track his movements along a course. To accurately determine the user's lap or stage time, the disclosed exemplary technique can start tracking the user's movements when the user's geolocation coordinates change. Alternatively, the disclosed exemplary technique can use a gyroscope, accelerometer, or any currently available or later developed motion sensor to detect any initial movements by the user to indicate the technique should start tracking the user's movements. Once the user's lap or stage time has been determined, the user can share the lap or stage time with others.

The disclosed exemplary technique tracks a user's movements using geolocation technology, such as global positioning system (GPS) technology, Bluetooth, Near Field Communication (NFC) technology, and other currently existing or later developed technology for determining the physical location of a user.

Further, the user can look at a history of his lap or stage times at a particular course or overall. Also, as previously mentioned, because the user can share lap or stage times with other users, the user can access and view any lap or stage time shared by other users. Consequently, users cannot access or view any lap or stage time not shared by other users. Lap or stage times can be sorted based on any subset of information of which lap or stage time is composed, such as time, username, etc. The disclosed exemplary technique can also sort based on any other analyzed statistic, such as fastest start, highest speed, fastest average speed, highest average speed, longest acceleration, longest braking etc.

As mentioned previously, the set of geolocation positions corresponds to and map to physical geolocation positions on the course. In an exemplary embodiment, the set of geolocation positions can be a set of GPS coordinates, and in another embodiment, the set of geolocation positions can be transponders positioned at certain geolocations along the course. Any currently existing or later developed technology can be used for transponders indicating the set of geolocation positions.

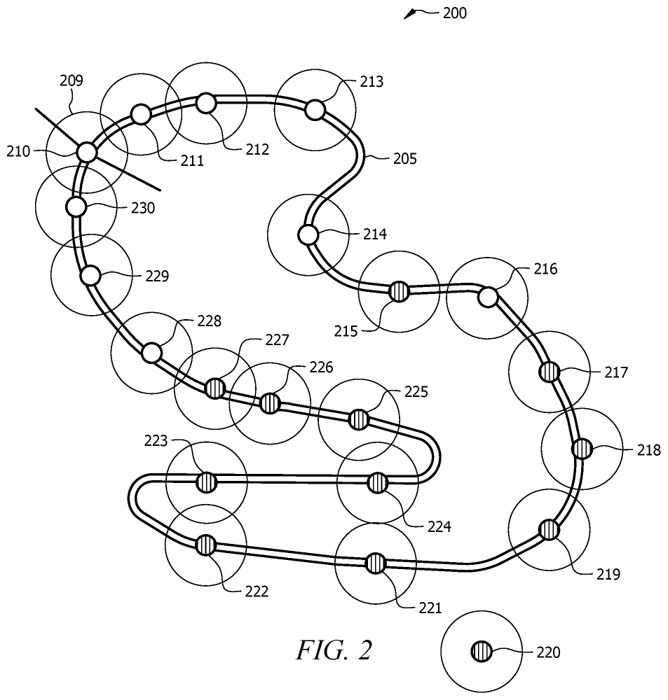

The disclosed exemplary technique needs to provide accuracy and precision so that users cannot cut the course in order to get a better lap time. To provide accuracy and precision and to deter any cheating, the disclosed exemplary technique tracks the movements of users and authenticates the user's movements against the set of predetermined geolocation positions by using a predetermined distance from the predetermined geolocation positions. The predetermined distance creates an area that the user needs to pass through to successfully authenticate the predetermined geolocation positions. The predetermined distance may be set and modified by the course proprietor to fit a particular track's width and overall size. Alternatively, the system can automatically change the predetermined distance based on history of users not appearing in certain portions of the area formed by the predetermined distance of a geolocation position. Other factors can be used for refining the predetermined distance. FIG. 2 further discusses the accuracy and precision of the disclosed exemplary technique.

Further, in at least one embodiment, the disclosed exemplary technique allows users to discover or find nearby courses by determining the geolocation of the user and retrieving the geolocation of nearby courses. The disclosed exemplary technique can engage geolocation technology or services to identify nearby or established courses. In this embodiment, other types of geolocation technology or services can be used to determine the geolocation of the user, as compared to the geolocation technology or services used for tracking the user's movements on a course. The exemplary embodiment can use cellular service to determine the geolocation of the user. In another exemplary embodiment, the disclosed exemplary technique has access to a list or map of established courses. The list or map of established courses may include physical addresses, GPS coordinates, or any other type of group of numbers used to indicate the geographical location of a user.

In another exemplary embodiment, users can use and join groups for sharing lap or stage times. These groups of users may base membership on invitation, geographic availability, or any other factor. Groups of the exemplary embodiment can facilitate messaging between the members of the group, and messages between group members can be supported by SMS, a messaging system supported by the disclosed exemplary technique, or any other messaging system, currently existing or later developed. Further, users may initiate races for members of the group, which is discussed in further detail below.

A user can also have a profile for aggregating the user's lap or stage times at various courses. The profile can also include a list of the user's friends and their best lap or stage time at the various courses. The friend list may instead present information that the user has indicated that he wants to see with each entry on the friend list. Alternatively, the list of the user's friends may present any information that each friend has indicated to be shown on the user's friend list. In another embodiment, the technique can provide a feature for following and un-following specific users. With following specific users, the user can get updates on the activity of the users he is following.

One exemplary embodiment allows users to win prizes or trophies associated with a course. A course proprietor may allow for any number of prizes or trophies for his course, and the disclosed exemplary technique can present a view of the winners of the prizes or trophies authorized by the course proprietor at a course. In another exemplary embodiment, trophies or prizes can be given to the user with the best lap or stage time within a group of users.

The advantage of the exemplary embodiments herein allow for less hardware to be used to accomplish the disclosed principles, and allows for greater rate of efficiency, accuracy, and prevision because there is known information and data against which the user's course can be compared and authenticated.

Exemplary applications can be implemented via one or more secure websites, or other similar dedicated sites accessible via a computer network. While in one embodiment the disclosed techniques are used with mobile computing devices, in another embodiment, the disclosed techniques may be used with any combination of mobile computing devices and computing components or devices. Other embodiments can provide specific capabilities with the disclosed techniques facilitated by a physical location, such as a sports stadium or other similar course establishments accessible by patrons.

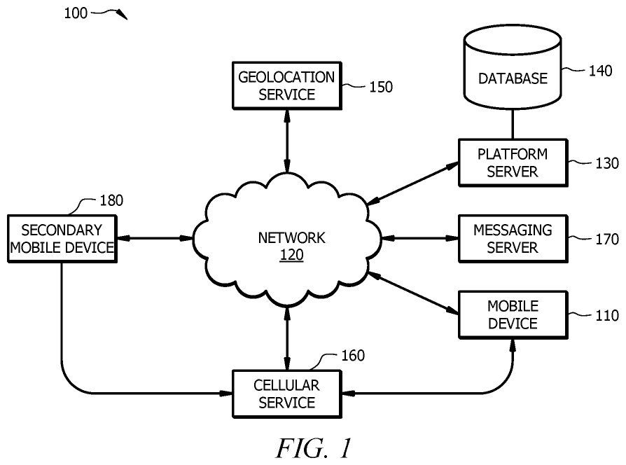

FIG. 1 illustrates a block diagram of an exemplary user tracking system 100 in accordance with one or more embodiments. The exemplary system 100 can use the principles as disclosed with the user tracking technique. The user tracking system 100 provides tracking of a user through the use of a mobile computing device 110 and a client application on the computing device 110. The client application on the mobile device 110 (also called a client terminal) can connect to and access other applications and any other available technology on the mobile device 110. For example, the client application can access the camera or the geolocation services of the mobile device 110. The client application provides a graphical user interface for user interaction and to present any views as disclosed with the user tracking technique. The client application interfaces with input and output devices of the mobile device, such as a touchscreen of a smart phone. The client application can have access to a user's geographical location, location data, product and social network data, and communications protocols. Although the exemplary embodiment illustrates a single mobile device 110, any number of mobile devices can be used with the user tracking system 100.

One or more mobile devices 110, each with a client application, may be coordinated by a user tracking server 100, and can comprise mobile telephones, personal data assistances, tablet computers, notebook computers, or any other type of computing device. Within the user tracking system 100, the mobile device 110 is configured to connect to the user tracking server 130 via a computer network 120, such as the Internet. The user tracking server 130, which is also referred to herein as the platform server, is also configured to connect to a computer network 120, such as the Internet. In other embodiments, the computer network 120 can be a private access network. Of course, other means of connecting the mobile device 110 and the user tracking server 130 to a computer network 120 may also be used, either currently existing or later developed.

In an exemplary embodiment, the system 100 includes geographic localization of the mobile device 110 associated with users accessing the system 100. In one embodiment, the use of a geolocation service 150 for the system 100 may be provided or confirmed using GPS satellite location techniques. More specifically, one or more GPS satellites may be used in connection with GPS-based hardware/software in one or more of the context to determine the geographical location of the mobile device 110. Alternatively, the geographic location of one or more of the mobile devices 110 may be provided or confirmed using one or more cellular towers of a cellular service 160. In such embodiments, geographic location of the mobile device 110 is determined by a mobile telecommunications network via, for example, the location of the cell tower (i.e., the actual node of a cell tower servicing the mobile device 110), which is updated by the mobile device 110 when it changes from one cell tower to another.

Still further, the mobile device 110 may comprise an application loaded thereon that facilitates the determination of the geographic location of the mobile device 110 having the application. Moreover, such an application may be specifically associated with or developed by the provider of the system 100, or by a third party. In yet other embodiments, a computer network 120 may simply detect when the mobile device 110 is within a predetermined distance. In these embodiments, a mobile application may provide the location of the mobile device 110 by pinging a local network. Alternatively, rather than an application, the mobile device 110 may include geolocation hardware or software, such as RFID technology or Bluetooth. Other possible location technologies or techniques, whether specifically in a mobile device application or not, may include GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, Wi-Fi or other wireless computer/telecommunications technology location systems, Internet Protocol (IP) address, BEACON, and RFID technology. Of course, these techniques for location determination are simply exemplary, and thus can encompass any computing device location technique, either now existing or later developed.

In addition to determining and confirming the geographic location of the mobile device 110, the system 100 can limit access by users based on geographical location of the mobile device 110. For example, a course proprietor may require patrons to pay a fee to use the course, and only paying patrons are given an access code or password to access a user-restricted set of geolocation positions representing the course. Such access codes or passwords may be the same for all users wishing to access the system, or the course proprietor can access the system 100 to authorize the user to access the set of geolocation positions.

Access codes can also be provided in other embodiments so that multiple mobile devices of the user can interact with the system 100. For example, a user may utilize two mobile devices in accessing the user tracking system 100, such as a mobile phone and wearable technology such as a smartwatch, and uses the smartwatch for tracking his movements on the course and uses the mobile phone for viewing his profile or friend list. Access codes allow the multiple mobile devices to synchronize information with each other.

In another embodiment, the mobile device 110 can be safely attached to the vehicle. A mount can be used to attach the mobile device 110 to accurately track the vehicle's course and to prevent the mobile device 110 from moving while the user is logging laps on the closed course. The mount can position the mobile device 110 into a position where the user can easily access between logging laps on the closed course. For example, the mobile device 110 can be mounted in a safe and stable location on a vehicle. In at least one example, the mobile device 110 may include GPS logging capabilities or a mobile device such as a phone in communication with a GPS logging capable secondary device.

The user tracking server 130 can be a centralized computing system or device for coordinating a plurality of mobile devices 110. The server 130 coordinates and communicates through a computer network 120 such as the Internet with geolocation services 150, cellular service 160, and other services available to the mobile device 110. The server 130 also communicates and coordinates with a database 140 for user information, lap data, and information collected from the mobile device 110. The database 140 may also comprise data from course proprietors, including the set of geolocation positions of courses, trophies and prizes for closed courses, and any other information of the courses.

The user tracking server 130 can comprise a front end server for handling data requests or web page requests from users, processing the requests and returning the data, an application programming interface server, a database server, and a location determination server. The user tracking server 130 can also contain any number of servers required to operate the interactions between the user tracking server 130, the mobile device 110, and the geolocation service 150, the cellular service 160, and any other component of the system 100.

The messaging server 170 of the user tracking system 100 provides the infrastructure for messaging between users. The messaging server 170 also facilitates messages from users to course proprietors, so that users can report other users, problems with the course, or any other messages meant for the course proprietor. The messaging server 170 can use SMS, a messaging interface for use only with the system 100, or any other type of messaging technology to facilitate the messaging as disclosed. The messaging server 170 can interact with the user tracking server 130 to create a graphical user interface within the client application for messaging between users. Any currently available or later developed messaging or communication protocol can be used with the messaging server 170.

As previously mentioned, the mobile device 110 can comprise an application or service loaded thereon that facilitates the determination of the geographic location of the mobile device 110 having the application, and a geolocation service 150 interfaces and communicates with the application through the computer network 120. The geolocation service can comprise GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, Wi-Fi or other wireless computer/telecommunications technology location systems, Internet Protocol (IP) address, BEACON, and RFID technology. Again, these technologies and techniques are simply exemplary and thus can encompass any geolocation technology or technique, either now existing or later developed.

In another embodiment, the system 100 can provide a graphical user interface for course proprietors to interact with patrons of their courses or other third parties to configure any advertising or sponsored content for particular courses. In yet another embodiment, the graphical user interface allows the proprietors to access a graphical user interface for generating the set of geolocation positions representing the course. Further discussion regarding generating the set of geolocation positions is below.

In another embodiment, the system 100 can access third party data sources to get authentication information. For example, the system 100 can access Facebook services in order to get user information and authentication information, and accordingly, the user can use Facebook to create an account in the system 100. Other social media verification data sources can be used, currently existing or later developed.

The use of social media resources is not required because users are able to create a user account with the system 100 without the use of social media information. The use of social media allows for easier and faster user authentication because in some exemplary embodiments, users can be required to input their username and password upon each activation of the system 100.

A secondary device 180 can also be used with the system 100 so that a user is not using a mobile device 110 or mounting their mobile device 110 onto their vehicle. The secondary device 180 can be another computing device for tracking movements of the user, such as a GPS tracking unit that determines and tracks the unit's precise location at intervals. The secondary device 180 can store recorded geolocation data for later transmission and analysis, or the secondary device 180 can transmit recorded geolocation data to the server 130 using the computer network 120 or any other type of transmission technology. Another example of a secondary device 180 can be smartwatches or wearable technology that tracks geolocation of the user.

FIG. 2 is an exemplary illustration 200 of a set of geolocation positions on a course. As previously discussed, the set of geolocation positions 210-230 are located on the course 205. While illustrated as a closed course, it would be understood that the course 205 could also be a point-to-point course utilizing the same principles disclosed herein. A lap may be utilized in reference to a closed course, while a stage may reference a point-to-point course. However, it would be understood that either course can be interchanged, and lap or stage can be interchanged, utilizing the principles of operation, detection, or analysis disclosed herein.

The set of geolocation positions 210-230 are made by the course proprietors, and in creating the set of geolocation positions 210-230, proprietors use a similar tracking technique to the tracking of users. The proprietor activates geolocation set creation with the system 100 on his mobile device 110, and the system 100 immediately determines the proprietor's geolocation. This first geolocation is the start/finish point for the proprietor. As the proprietor moves along the course, the system 100 records the proprietor's geolocation at certain intervals. In one embodiment, the system 100 records the proprietor's geolocation every 16 meters. These intervals can also vary in amount of distance. When the system 100 detects that the proprietor has either stopped moving or has reached the start/finish point again, then the set of geolocation positions has been created. In another embodiment, the proprietor can deactivate geolocation set creation on his mobile device 110. The system 100 then stores the set of geolocation positions into the central database 140 for retrieval by users.

Referring back to FIG. 2, point 210 represents the starting geolocation of the user in the present exemplary embodiment; in other embodiments, any of the other geolocation positions can be the starting geolocation of the user. The system 100 determines the starting geolocation position for the user and the starting geolocation position among the set of geolocation positions 210-230 by calculating the user's current geolocation and then comparing the user's current geolocation against the set of geolocation positions 210-230. Because a user may not be on or in the exact geolocation position provided in the set 210-230, the system calculates a distance from the user's starting geolocation position to each geolocation position in the set 210-230 to determine whether the user is within a predetermined distance from any of the set of geolocation positions 210-230 or whether a user is in the area formed around each of the set 210-230. For example, in the exemplary embodiment, the area 209 is formed based on a predetermined distance from the geolocation position 210. If the user's geolocation position is within the area 209, then the system 100 can map the user's geolocation position to the geolocation position 210 and the system 100 can mark the geolocation position 210 as completed.

Similarly, when the user is moving on the course, the system 100 retrieves the geolocation position of the user to compare against any of the set of geolocation positions 210-230. The system 100 calculates the distance between the user's current geolocation position and the each geolocation position of the set of geolocation positions 210-230. If the calculated distance between the user's current geolocation position and a particular geolocation position of the set 210-230 is equal to or less than a predetermined distance, such as 8 meters, then the system 100 marks the particular geolocation position as complete. In an alternate embodiment, the system 100 determines whether the user's current geolocation position is within the area based on the predetermined distance from any of the set of geolocation positions 210-230, and if the user's current geolocation position is within the area of any of the geolocation positions 210-230, then the geolocation position of the set 210-230 for the area is marked as completed.

In another exemplary embodiment, the system 100 can determine whether the user's current geolocation position is within the areas around of geolocation positions that have not been marked as completed. For example, in an exemplary embodiment, the system has marked geolocation locations 210, 211, 212, 213, and 214 as complete because the user's tracked movements and tracked geolocation indicated that the user has traveled through the circles formed by each geolocation position. However, the user did not appear within the area around geolocation 215 and did appear within the area around geolocation 216. Accordingly, geolocation 216 is marked as complete by the system 100 even though the user did not appear within the area of geolocation 215.

In another embodiment, because the course proprietors can create and modify the set of geolocation positions 210-230 of the course 205, course proprietors can also set the predetermined distance and corresponding area for all the geolocation positions 210-230 or the course proprietors can set a predetermined distance and corresponding area for each of the geolocation positions. For example, the course proprietors can set the predetermined distance to be 8 meters for all of the geolocation positions, but they also have the option to set one of the geolocation positions to 6 meters instead of 8. Course proprietors may modify the predetermined distance to more accurately reflect the course 205.

FIG. 2 illustrates the completed geolocations not shaded (210, 211, 212, 213, 214, 216, 228, 229, and 230) and the others shaded in based on a trend line mechanism as used by the system. In the exemplary embodiment, each established course in the system 100 has a success rate (also referred herein as a predetermined success threshold). The success rate is used to make sure that users do not cut the course or cheat. The success rate may be defined by the course proprietor or by the system, based on an ongoing aggregation and normalization of the completion rates by users. In one embodiment, the success rate is set at a default of 70%. The success rate is the threshold for the system 100 to consider a lap or stage as complete, and the success rate is based on the number of completed geolocation positions against the total number of geolocation positions in the set of geolocation positions 210-230 for the course 205. For example, the exemplary course 205 of FIG. 2 has a predetermined success rate of 70% and has 21 geolocation positions in the set of geolocation positions 210-230. If a user completes only 9 of the 21 geolocation positions of the set 210-230, the user's completion rate is only 42.8% which is below the determined success rate of 70% and accordingly the user did not complete the lap or stage along the course. When the system 100 has determined that the user has not completed the lap around the course 205, then the lap is not recorded as a lap in the system 100. In one embodiment, the timer also continues to run without resetting and thereby creates a track cut penalty. However, if the user completes 17 of the 21 geolocation positions of the set 210-230, the user's completion rate is 80.95% which is above the determined success rate of 70% and accordingly the user completed the lap. When the system 100 determines that the user has completed the lap, then the lap is counted, lap information is recorded, and the timer for the lap is reset.

Further, in another embodiment, after the system determines that the user has completed the lap, the system 100 resets the set of geolocation positions to incomplete.

Distance calculation and geolocation functionality can be provided through currently available technology, such as CoreLocation, or later developed technology and services.

The use of the success rate also accounts for inconsistencies and errors of geolocation technology and services, such as a weak signal reception by the mobile device 110. For example, point 220 of FIG. 2 is a geolocation position that was recorded into the set of geolocation positions 210-230 but is not on the course 205. When the proprietor created the set of geolocation positions 210-230, the geolocation services may have glitched or some other error may have occurred when attempting to record a geolocation position on the course 205 between point 219 and 221, and so the system 100 may have inadvertently recorded point 220 using geolocation coordinates not on the course 205. The success rate accounts for these errors because the system 100 recognizes that a user cannot usually mark each geolocation position of the set 210-230 as complete, especially geolocation positions not along the course 205.

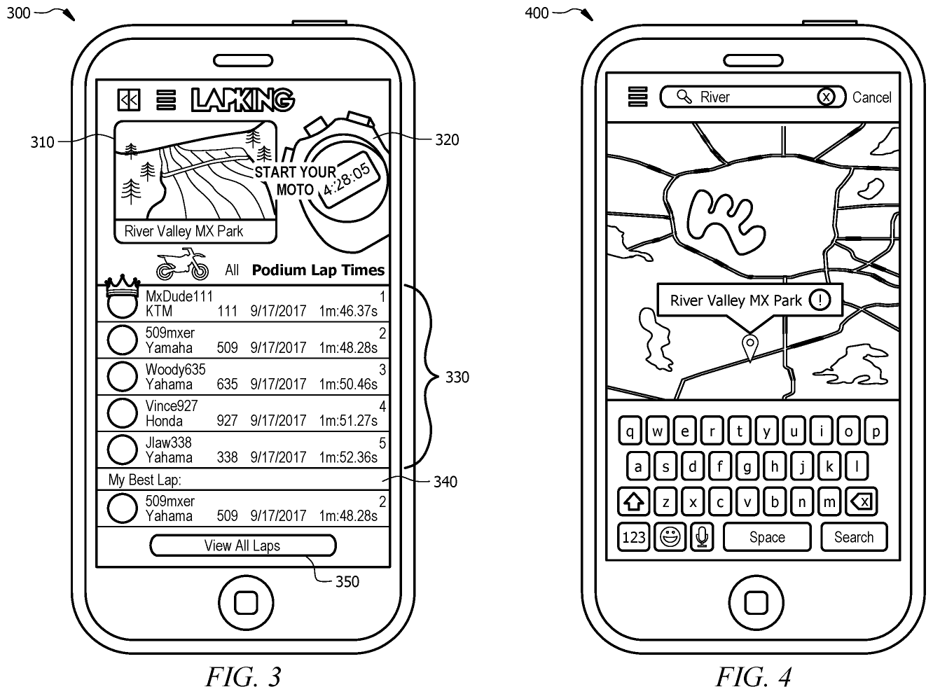

FIG. 3 illustrates an exemplary embodiment of a screenshot 300 of a graphical user interface, in accordance with the disclosed principles, for a course with information about the best lap or stage times for the course, and for a user to start tracking his movements along the course. The screenshot 300 provides an exemplary image 310 of the course with the course's location. As shown in the screenshot 300, the graphical user interface provides a button 320 for activating tracking of the user's movements on the course. In the exemplary embodiment, the graphical user interface provides a podium list 330 of users with the best lap or stage times at the course. Each lap or stage entry of the podium list 330 provides the user's screenname, the lap time, the date of the lap time, and the user's rider number, and the user's lap ranking. The list 330 can have any number of entries shown to users. Additionally, the exemplary embodiment is directed to racing and accordingly, each entry provides the brand of the user's preferred choice of vehicle or transportation. For example, brand of tennis shoe for runners, bike for BMX or bike riders, or motorcycle for motocross. The exemplary embodiment provides the top five lap or stage times at a course; however, in other embodiments, more lap times can be viewed. The graphical user interface also shows a section 340 for the user's best lap entry at the course, and in the present exemplary embodiment, the user's best lap time coincides with the second best lap time at the course. A button 350 below the user's best lap or stage section 340 is available for the user to select and use to view the best lap or stage times for all users.

In another embodiment, the graphical user interface providing information for a course can also include other information about the course, such as a physical address, phone number, and website when the image 310 is selected. Users can also filter the information for the course and the entries of the list 330 to show specific information based on a variety of filters.

FIG. 4 illustrates an exemplary embodiment of a screenshot 400 of a graphical user interface demonstrating geographically finding a nearby established course. In the present exemplary embodiment, the user can search for courses based on the name of the course as established, on the geographical proximity to the user, and any other search factors available. The screenshot 400 illustrates a map view of the searched-for course for selection by the user. As previously mentioned, the user can search for courses using any type of geolocation service, including GPS and cellular technology. Further, user can utilize map functionality that can be found in other currently available and later developed map services, like zooming in or zooming out.

In another embodiment, some courses may be found after the user has visited the course and the course proprietor has provide authorization to the user to access information about the course. Accordingly, some courses may be a private course where membership is restricted.

FIG. 5 illustrates an exemplary embodiment of a screenshot 500 of a graphical user interface for deactivating the tracking of the user's movements on a course, where the interface also shows previous lap times on the course. In the present exemplary embodiment, the user pressed the button 320 of FIG. 3 to get to the present view of the graphical user interface as provided in screenshot 500. In the exemplary screenshot 500, the graphical user interface provides a button 510 for starting and stopping the tracking functionality of the user tracking system 100. The present exemplary screenshot illustrates the button 510 for stopping the tracking functionality and provides the words “Stop Timer”; in another exemplary embodiment, the button 510 provides activating of the tracking functionality and the words “Start Timer.” Additionally, in the present exemplary embodiment, the graphical user interface provides a list 520 of the user's previous lap or stage times at the selected course, and each entry on the list 520 provides the lap number and the completed lap time. The present exemplary screenshot 500 provides a stopwatch 530 at the bottom of the graphical user interface, and the stopwatch 530 can provide a real-time and current visualization of the user's time as he moves on the course. In another embodiment, users can turn on/off real-time updates to a leaderboard for the course.

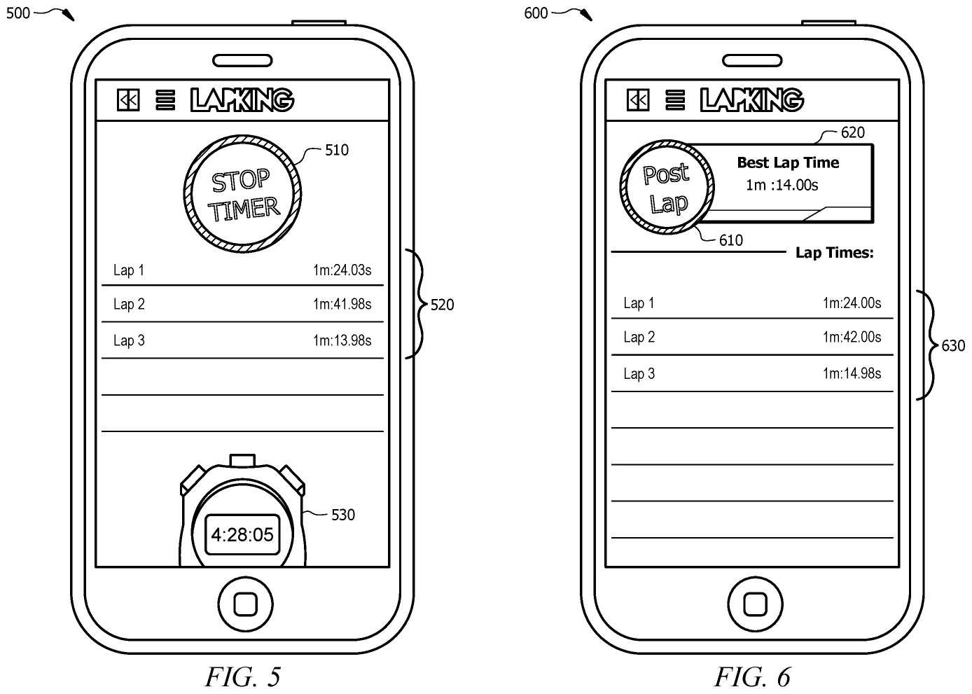

FIG. 6 illustrates an exemplary embodiment of a screenshot 600 of a graphical user interface for posting a user's best lap or stage time after the user completed a lap or stage and the lap or stage time for the lap or stage is the user's best time so far. In the present exemplary embodiment, the user can press the button 610 to share his lap information, which includes his lap time and the lap rank, with others, such as friends or the public. The graphical user interface in the exemplary screenshot 600 has a header 620 for the user's most recent lap time, and in the present screenshot 600, the user's most recent lap time is his best lap time so far, so when posted, others can also see that the posted lap information is the user's best lap so far. The graphical user interface, again, provides a list 620 of the user's previous lap times at the selected track, along with the lap information of the lap that the user just completed, and each entry on the list 630 provides the lap number and the completed lap time. In another embodiment, the graphical user interface can provide a marker for the user's best lap so the user can more easily find the best lap in the list 630.

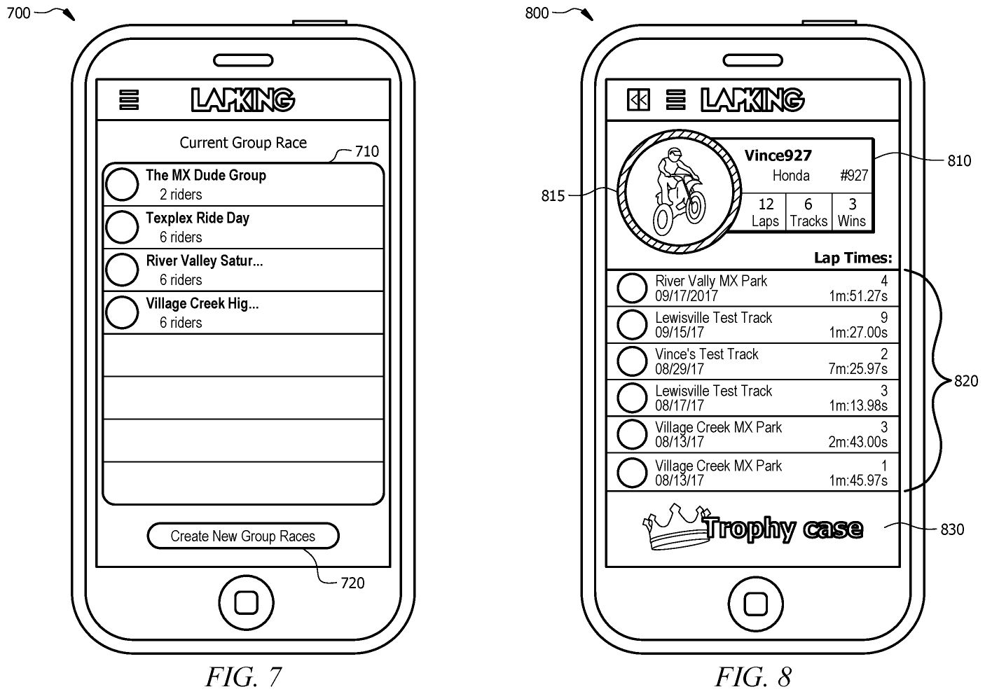

FIG. 7 illustrates an exemplary embodiment of a screenshot 700 of a graphical user interface demonstrating groups of riders currently racing or active along a course. The system 100 provides a graphical user interface for racing groups. The screenshot 700 of the exemplary graphical user interface illustrates a list 710 of current group races. The system can populate the list 710 based on a variety of factors, such as groups that the user has joined, groups within a predetermined geographical vicinity, groups at a course that the user frequents, currently racing groups, etc. The entries of the list 710 comprise the name of the group and the number of users within the group, which may change as users join or leave the group. In an alternative embodiment, the number of users may be based on the number of users currently racing or currently using the client application on their mobile device. Groups decrease the racing risk factors, and allows users to show up at a course during the duration of the group race and to log laps or stages at the users' convenience. Group races can also provide trophies or prizes among the group members.

The system also allows users to create new group races via the button 720 on the graphical user interface of screenshot 700. In creating a group race, the user can specify a particular course and can invite friends of the user to the group race. The user can also specify the group as a private group, where membership is restricted, or a public group, where membership is not restricted. The user can specify any number of factors for group races.

FIG. 8 illustrates an exemplary embodiment of a screenshot 800 of a graphical user interface for a user profile. In the user profile of the screenshot 800, information about the user can be provided in a header 810, such as a profile picture 815 of the user, the brand of vehicle used by the user, the number of tracks the user has attended, the number of trophies or prizes won by the user, the number of best lap or stage times the user has, the number of laps or stages posted by the user. User information for the header 810 or in the user profile may be personalized or access-restricted by the user. The screenshot of the graphical user interface also includes a list 820 of the user's laps at various courses, and each entry on the list 820 includes the name of the race track, the date of the lap entry, the user's lap time, and any placement of the user's lap at the race track. Any other lap information may also be provided with each entry of the list 820. Also illustrated in the screenshot the graphical user interface is a button 830 to view any trophies or prizes won by the user.

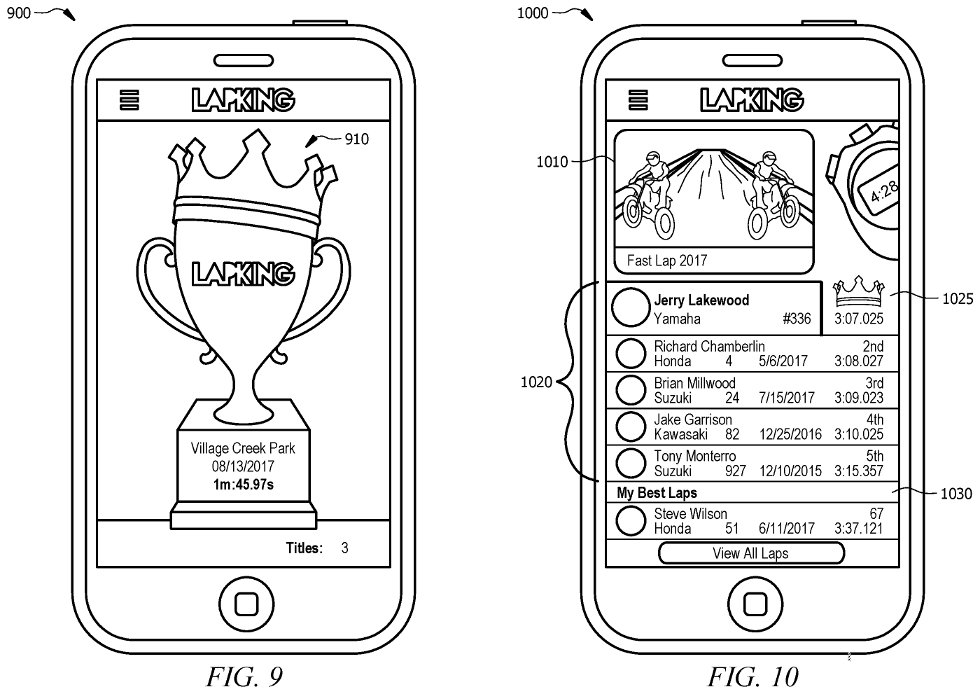

FIG. 9 illustrates an exemplary embodiment of a screenshot 900 of a graphical user interface of a trophy 910 available to the user with the best lap time at a course. The trophy may have information about the best lap time by the user, such the date of the lap, the lap time, and the course of the lap. At the bottom of the graphical user interface, the system can provide the number of trophies, titles, or prizes own by the user. A link to the exemplary graphical user interface can appear in the user profile of FIG. 8.

FIG. 10 illustrates an exemplary embodiment of a screenshot 1000 of a graphical user interface demonstrating the user tracking system facilitating video streaming of racing competitions and events, and presenting information about the racing competition and events with a user's information. These racing competitions may be pay-to-play competitions. As shown in the screenshot 1000 of the exemplary embodiment, the graphical user interface includes an image 1010 of a racing competition. The image 1010 can accompany information about the racing competition, such as the name and location of the racing competition. The user tracking system 100 can be used to provide viewers and fans of the racing competition the ability to get a real-time view and updates of the competition. The graphical user interface comprises a list 1020 of the competitors, each having a mobile device with the client application of the system 100. Each entry of the list has information about the competitor, such as the competitor's name and their vehicle if one is used, their number in the competition, and any lap or stage information. For example, in the exemplary embodiment, each entry has the competitor, the vehicle if one is used by the competitor, the competitor's entry number in the competition, the competitor's best or stage lap, including information about the date of the lap or stage and the lap or stage time, and the competitor's current standing in the competition. The list 1020 may also have a marker 1025 for indicating the competitor with the fastest lap time. Also illustrated in the graphical user interface of the exemplary screenshot, is the user's best lap information in the section 1030 below the list 1020, and this section 1030 provides similar information as the list 1020.

In other embodiments, the image 1010 can be a video stream of the racing competition from a commentator's perspective, or from any racer's perspective. The video stream may be computer-generated representation of the course with each participant's real-time location along the course.

The competitions as contemplated above may take over a large period of time so as to allow as many competitors as possible. These competitions may also take place over multiple courses, so the system can provide additional graphical user interfaces that provide similar information as the graphical user interface in screenshot 1000.

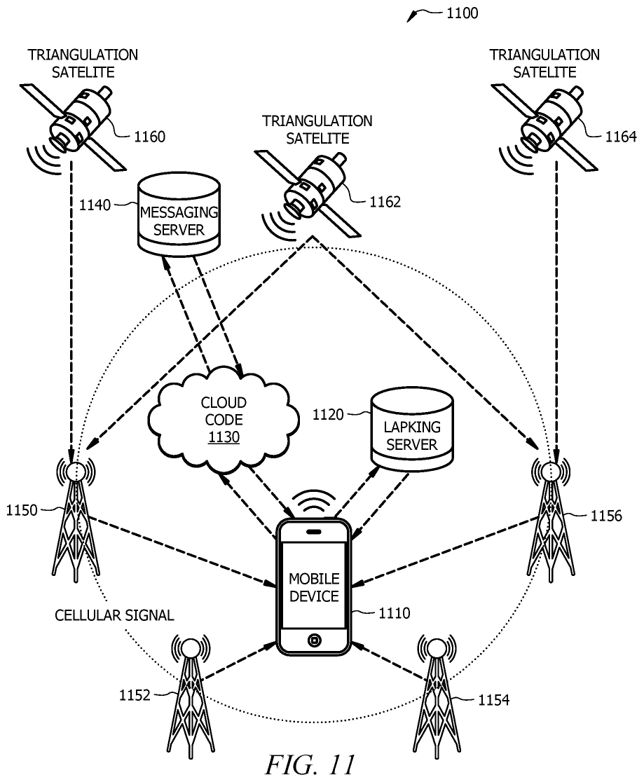

FIG. 11 is another block diagram of an exemplary embodiment of the user tracking system 1100. The user tracking system 1100 includes at least one mobile device 1110 for a user. The mobile device 1110 connects to the server 1120 and to the cloud code 1130 for receiving and sending data from databases (not illustrated) connected to the server 1120 and the cloud code 1130. The cloud code 1130 also connects to a messaging server 1140 for providing communication protocols between the mobile device of the user and mobile device of other users. The mobile device 1110 also connects with cellular towers 1150, 1152, 1154, 1156 which retrieve geolocation data for triangulation data from satellites 1160, 1162, and 1164. In the exemplary embodiment, the geolocation data is based on triangulation of multiple satellites 1160, 1162, and 1164.

The cloud code 1130 allows for push notifications to the mobile device 1110, regardless whether the client application on the mobile device 1110 is active or not. The cloud code 1130 also interfaces the mobile device 1110 for and/or with any network-based or cloud-based services for the client application on the mobile device 1110, such as geolocation services and social networking services. The cloud code 1130 comprises currently available and later developed technology for interfacing between the mobile device 1110 and the messaging server 1140.

In an exemplary embodiment, geolocation data can be calculated based on a triangulation of either multiple satellites 1160, 1162, 1164 or multiple cellular towers 1150, 1152, 1154, 1156. Geolocation data may be transmitted from the satellites 1160, 1162, 1164 to the cellular towers 1150, 1152, 1154, 1156 for transmission to the mobile device 1110. The geolocation data is then processed by the client application of the mobile device 1110 to perform the principles disclosed in other exemplary embodiments.

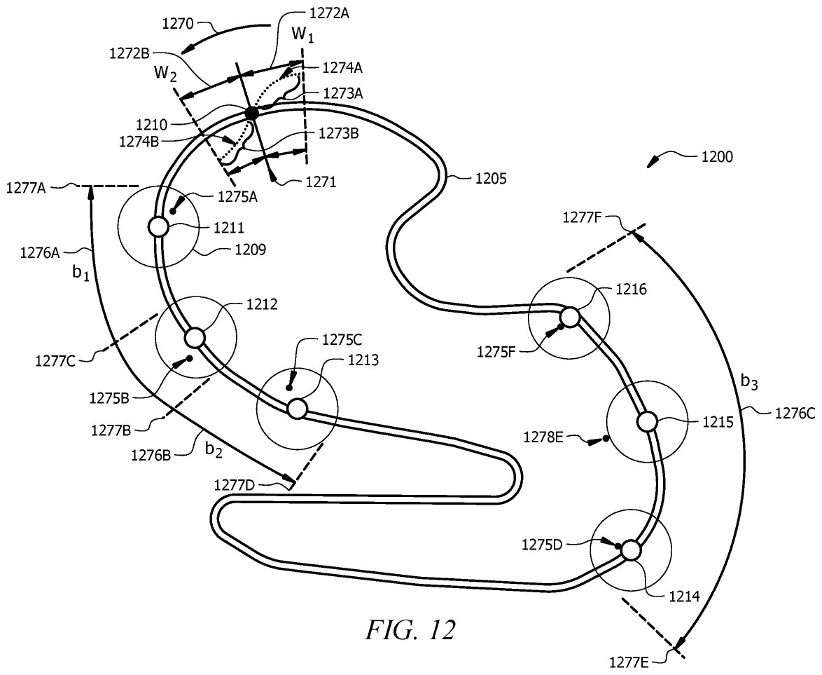

FIG. 12 is an illustration of a set of geolocation positions on a course as logged and compared by system 1200. The system 1200 can include one or more client terminals and one or more servers in communication with the client terminals via a computer network similar to the systems disclosed in FIGS. 1 and 11. A course 1205 may be a closed course that begins at a start/finish line 1271, or may be an open course that begins at point A, and ends at a point B, and also known as a point-to-point course. A predetermined set of coordinates 1210, 1211, 1212, 1213, 1214, 1215, or 1216, can overlay the course 1205 in a manner that allows for a comparison or analysis of the number of predetermined set of coordinates that have been statistically matched to a set of recorded geographical movements 1273A, 1273B, 1275A, 1275B, 1275C, 1275D, 1275E, or 1275F recorded with a mobile, computing, GPS, or logging device. The predetermined set of coordinates 1210, 1211, 1212, 1213, 1214, 1215, or 1216 may also include additional information, such as, but not limited to, detail windows, detection windows, search radiuses, longitude, latitude, or sea level, other geographical information, or a combination thereof. While the present disclosure may reference a course 1205 it would be understood that the course 1205 may be created from, or included as, part of a predetermined set of coordinates 1210, 1211, 1212, 1213, 1214, 1215, or 1216.

Course 1205 may have one or more trigger points 1210 that are linked and/or associated with a start/finish line 1271. The start/finish line 1271 may on a point-to-point course be associated with a start line associated with point A, and a finish line associated with point B. In the closed course example depicted, the line 1271 represents both the start and the finish line 1271. The trigger point 1210 can in at least one embodiment, be placed on or next to the start/finish line 1271 when viewed in reference to a map of a course 1205. A set of detail windows 1272A/1272B may be created by the system 1200 before or after one or more trigger points 1210. A detail window 1272A/1272B is an area around a trigger point 1210 or start/finish line 1271 in which a set of recorded geolocational movements or points 1274A or 1274B may be located. The set of recorded geolocational movements 1274A/1274B may be analyzed to determine which individual point from the set of recorded geolocational movements 1274A or 1274B is closest to the trigger point 1210 or the start/finish line 1271. In at least one embodiment, what is shown as two separate detail windows 1272A and 1272B may be a single detail window within which a single reference point is calculated or determined. The size of the detail windows 1272A/1272B, in at least one example, is relative to the velocity or speed of a user's set of recorded geolocational movements 1274A/1274B (or the full set of recorded geolocational movements 1274A/1274B, and additional recorded points such as, but not limited to 1275A, 1275B, 1275C, 1275D, 1275E, and 1275F), to allow for a calculated or specified number of recorded points to fall within. For example, a client terminal (a mobile device or secondary device as illustrated in FIG. 1 or 11) may capture a geolocational movement every tenth ( 1/10) of a second, this may be utilized to the calculate the size needed for each detail window 1272A/1272B to allow for 10 geolocational data points to be recorded (or desired to be recorded) within each detail window 1272A/1272B.

For example, if the course 1205 is a closed course with a single start/finish line 1271, then the set of detail windows 1272A/1272B may be utilized before (detail window 1272A) or after (detail window 1272B) the start/finish line 1271 or trigger point 1210. Using multiple detail windows 1272A/1272B may allow for a ratio or other calculation to be performed to approximate the time the start/finish line 1271 is crossed. In at least one example, the trigger point 1210 can be considered the initial and/or last checkpoint for a course 1205. It would be understood that the set of detail windows 1272A/1272B may also be a single detail window in which data or reference points are calculated based on the set of recorded geographical movements 1273A, 1273B, 1275A, 1275B, 1275C, 1275D, 1275E, or 1275F.

The detail windows 1272A/1272B (collectively 1272) allow the system 1200 to determine and/or calculate the start/finish time for a segment, lap or course 1205. For example, a client terminal (not illustrated) may begin logging geolocation positions once started by a user, but the geolocation positions 1273A (before) and/or 1273B (after) will not be counted or authenticated until a user/client terminal has crossed the start/finish line 1271 and/or the trigger point 1210. Because the client terminal may not log a geolocation that is precisely on the start/finish line 1271 and/or trigger point 1210, there is a need to determine with as precise as accuracy as possible a lap, segment, or course start or finish time by choosing the geolocation position that is closest to the start/finish line 1271.

The detail window 1272 can be utilized to allow the system 1200 to check each geolocation that is within the detail window 1272 to determine the geolocation point that is closest to the start/finish line 1271 and/or trigger point 1210. In at least one example, the client terminal also checks geolocation points that are within the detail window before the start/finish line 1271 and/or trigger point 1210. The reason for this, is to capture the point in the set of points 1274A closest to the trigger point 1210 within the first detail window 1272A before the start/finish line 1271, and capture the point in the set of points 1274B closest to the trigger point 1201 within the second detail window 1272B after the state/finish line 1271. The captured points may also be referred to as reference points. In other examples, when only a single detail window is utilized, the closest point to the trigger point 1210 and/or start/finish line 1271 would be a reference point. These two points from the sets of points 1274A/1274B can then be utilized to determine and/or calculate when the start/finish line 1271 was crossed and create a reference point. The reference point can be, in at least one embodiment, a calculated value from two recorded points, or may be the geographical movement point that is closest to the trigger point 1210.

For example, based on the distance between reference points from the sets of points 1274A and 1274B and the distance between each reference point and the trigger point 1210, a ratio can be calculated that allows for an accurate calculation of the start/finish line 1271 crossing. In another example, if the trigger point 1210 is roughly halfway between the reference points and then the start/finish line 1271 was likely crossed at the time approximately halfway between the timestamps of reference points and. In at least one embodiment, a set of recorded geographical movements 1273A, 1273B, 1275A, 1275B, 1275C, 1275D, 1275E, or 1275F can be divided into subgroups utilizing the reference points. An example of this could be dividing the set of recorded geographical movements 1273A, 1273B, 1275A, 1275B, 1275C, 1275D, 1275E, or 1275F into lap groupings on a closed course, or point-to-point sets on an open course, an example of which could be the Tour De France.

The course 1205 may also be separated into buckets 1276A, 1276B, or 1276C between checkpoints or trigger points. In at least one example, the buckets 1276A, 1276B, or 1276C may represent laps or stages of individual laps. The buckets 1276A, 1276B, or 1276C may have overlapping start or end points 1277A, 1277B, 1277C, 1277D, 1277E, or 1277F. For example, between two check points 1211 and 1212 the bucket window 1276A may have start and end points 1277A and 1277B which include the check points 1211 and 1212 plus the radius or detection area 1209 around those check points 1211 and 1212, until specific calculations are made. The detection area 1209 for each check point 1211, and 1212 is included to allow for the analysis of any points that are within the detection area of each checkpoint 1211, and 1212. The bucket window 1276A may then be utilized to determine a bucket timing based on the first point (illustrated as geolocational point 1275A within the detection area 1209 of checkpoint 1211) within the bucket window 1276A and the last point (illustrated as geolocational point 1275B within the bucket window 1276A. The next bucket window 1276B may include the detection area around checkpoint 1212 and the detection area around checkpoint 1213, thus having endpoints 1277C and 1277D, and overlapping with bucket window 1276A. Further to this example, if the buckets 1276A, 1276B, or 1276C are created after analysis of a set of recorded geographical movements 1273A, 1273B, 1275A, 1275B, 1275C, 1275D, 1275E, or 1275F, then the point closest to each or the checkpoints or trigger points may be used as the start point/endpoint for each of the bucket windows 1276A, 1276B, or 1276C, and allow for an adjustment of the start/end points 1277A/1277B, 1277C, 1277D, 1277E, and/or 1277F to those closest points.

However, there may be situations as illustrated by bucket 1276C where one check point 1215 is missed or not authenticated because the user did not record a point 1278E within the detection area. Because the analysis did not authenticate this check point 1215, the bucket window 1276C may extend from check point 1214 to check point 1216, with starting point 1277E and end point 1277F. In some examples, when authentication of check point 1215 does not occur the time for that bucket or portion of the course 1205 may be ignored or removed from an aggregation list. However, in an alternative example, if the timing information for the bucket 1276C is substantially within normal ranges and check points 1216 and 1214 are authenticated then the timing information may be restored or the timing information for the bucket 1276C would be utilized in an aggregation list in spite of checkpoint 1215 not being authenticated. This means that a multi-factor authentication may occur so that more laps can be authenticated if a predetermined coordinate, such as checkpoint 1215, has been miss recorded or marked when the course 1205 is created. However, there will still need to be a threshold number of checkpoints authenticated in order to allow the lap or bucket to be authenticated.

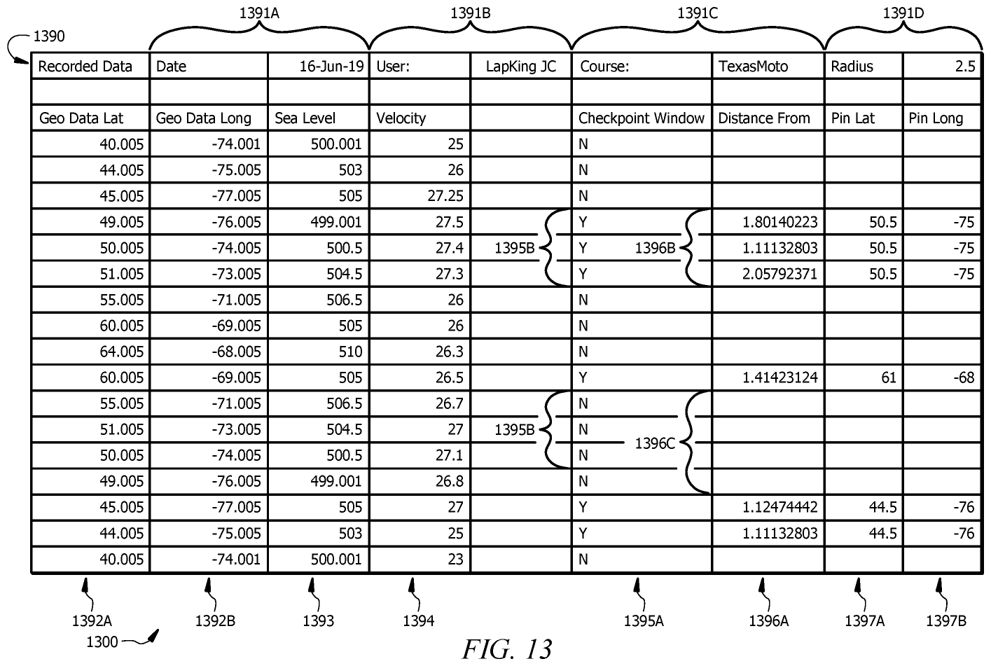

FIG. 13 is an illustration of a data table 1300 that can include a set of recorded geolocational movements 1392A, 1392B, 1393, or 1394, and a set of predetermined coordinates 1397A or 1397B. The data table 1300 may include header information 1390, such as, but not limited to, date 1391A, user identification 1391B, location information 1391C, and/or the search window radius 1391D. The data table 1300 may also include a set of recorded geolocation data points 1392A, 1392B, 1393, or 1394, where the recorded latitude 1392A, the recorded longitude 1392B, the height in relation to sea level 1393, or velocity 1394, or combinations thereof, or additional location, or movement data is recorded. The recorded geolocation data points can be compared to a set of predetermined coordinates 1397A or 1397B. The set of predetermined coordinates, can include marked latitude 1397A and marked longitude 1397B, and in at least one example the marked latitude 1397A and marked longitude 1397B are associated with one or more trigger points or check points along a track, course, waypoints, or other travel markers.

Analysis may be performed that compares the set of predetermined coordinates 1397A or 1397B with the set of recorded geolocation data points 1392A, 1392B, 1393, or 1394, to determine if any of the points in the set of recorded geolocation data points 1392A, 1392B, 1393, or 1394 are within a search window radius 1392D of the set of predetermined coordinates 1397A or 1397B. This analysis is illustrated by the checkpoint window 1395A, showing positive results 1395B and negative results 1395C.

In at least one embodiment, the set of recorded geolocation data points 1392A, 1392B, 1393, or 1394 are filtered by geolocational filters to allow for increased speed operations. For example, the geolocational data points 1392A, and 1392B may be filtered based on locational data such as, but not limited to, a predetermined coordinate like 50.5 or −75 and a radius or detection window of 2.5, accordingly any geolocational data point that is between 48 and 53, or −72.5 and −77.5 (depending on coordinates and other factors) will be considered for analysis, allowing other geolocational data points to be ignored for analysis or calculation purposes. It would be understood, that multiple filters or combination of filters may be utilized and logic such as, but not limited to AND, OR, NOT, XNOT, XOR, or other combinations thereof may also be utilized.

By filtering the set of recorded geolocational movements 1392A, 1392B, 1393, or 1394 by the geographical or related data rather than performing a calculation on each individual point, significant processing time can be saved. Because data may be gathered, in some examples, every tenth of a second or less (twentieth as an example), and a set of geolocational points may be recorded for several minutes, as an example a five (5) minute lap or stage may result in 3000 or more datapoints being recorded with many laps or stages being run in a single outing (recording) which can lead to large and cumbersome data sets for analysis purposes. Each of the recorded geolocational data points 1392A, 1392B, 1393, or 1394 may be filtered individually as columns, or rows of an array of data points. Using array filtering, each set of recorded data points can be divided or sub grouped for analysis or calculation purposes, as an example 3000 data points may be filtered down to 30 data points for analysis purposes, a saving of 99% and greatly improving the analysis, calculations, or other processing.

The checkpoint window 1395A may include data such as flags, numbers, letters, or other programable formula outputs to allow for a determination by a filter or calculation of a desired output result. The outputs stored in the location viewed as the checkpoint window 1395A can allow for a calculation like those seen in calculation window 1396A, with blank or null results 1396C, and formula or output calculations 1396B. In some example, block or null results 1396C would be ignored for timing or aggregation purposes, while in other examples these data points may be utilized for timing or aggregation purposes. The formula or output calculations 1396B may be the result of many different sequential or parallel calculations performed on a device such as, but not limited to a computing device or other device having at least one processor. Parallel calculations are performed at the same time, while sequential calculations are performed one after another. As can be seen in the data table 1300, the calculation window 1396A corresponds to the predetermined set of coordinates 1397A or 1397B. The calculations in calculation window 1396A, are performed after receiving a true or positive results 1395B in the checkpoint window 1395A which is a result of filtering operations such as array filtering. Allowing for large datasets to be segmented, divided, or sub-grouped into smaller groups that can be analyzed, or processed in a more efficient manner as an array can be filtered without having to have each individual point analyzed.

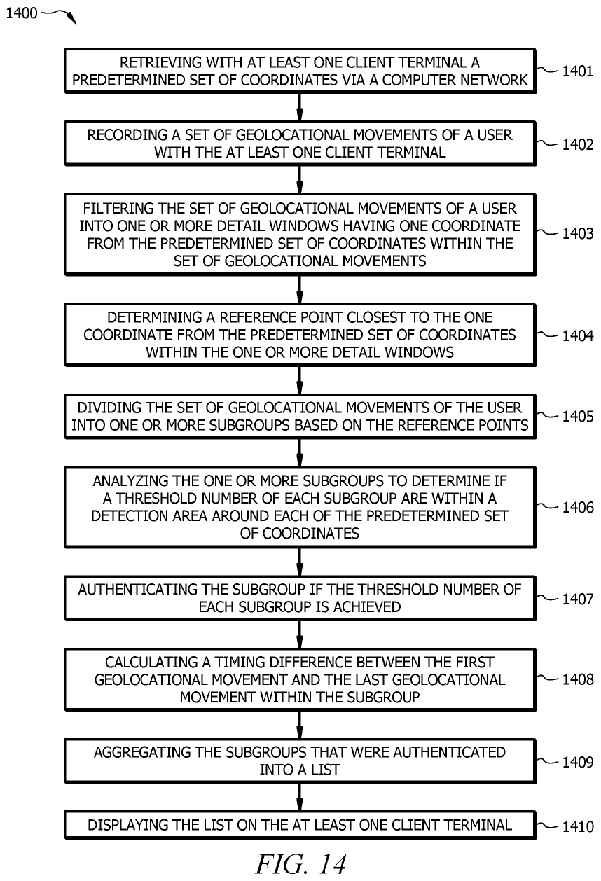

FIG. 14 is a flowchart illustration of method steps for performing calculations and analysis on a set of recorded geolocational movements. In at least one embodiment, retrieving with at least one client terminal a predetermined set of coordinates via a computer network 1401. The predetermined set of coordinates may be stored in one or more databases connected to a computer network directly or indirectly through a server or other computing device. The predetermined set of coordinates may be associated with a specific track, course, path, or set of organized travel information. In at least one example, the predetermined set of coordinates can include GPS data such as but not limited to, longitude, latitude, height related to sea level, velocity, time, or other location, position relationship, or movement information or data. In some examples, the predetermined set of coordinates may include at least one coordinate that corresponds to a trigger point, a checkpoint, a detail window, or a detention area.

In another step, recording a set of geolocational movements of a user with the at least one client terminal 1402. The set of geolocational movements that are recorded may include GPS data such as but not limited to, longitude, latitude, altitude, velocity, time, or other location, position relationship, or movement information or data in vector or point formats. In at least one example, the at least one client terminal may be a mobile device, a data logger, or other computing device having at least one processor. The recorded set of geolocational movements may also be recorded on a first client terminal, and then shared with a second client terminal. For example, a data logger (first client terminal) may be utilized to record the set of geolocational movements, and then share the set with a mobile device (second client terminal) through a wired or wireless connection such as wireless local area network (WLAN), Bluetooth, or other communication protocols.

Some examples may include gathering images, video, or Light Detection and Ranging (LIDAR) data that can be reconstructed to create a multi-dimensional or three-dimensional representation of the geolocational movements. Additionally, velocity, acceleration, momentum, or braking data may be recorded, calculated, measured, or determined from the recorded geolocational movements, to allow for a list, matrix, or visual display through a heatmapping of the various datapoints along the associated course. Similarly, the predetermined coordinates may also have image, video or LIDAR data associated with them that may be correlated for imaging or simulation purposes. For example, from the image, video, or LIDAR data, a simulation may be created that allows for a user to race themselves or other users with the authenticated data that has been gathered.

In another step, filtering the set of geolocational movements of a user into one or more detail windows having one coordinate from the predetermined set of coordinates within the set of geolocational movements 1403. The set of geolocational movements of a user may include GPS data such as but not limited to, longitude, latitude, altitude, velocity, time, or other location, position relationship, or movement information or data, with each field being independently filterable. For example, an array filtering system may be utilized to allow for simultaneous filtering of multiple parameters or fields. In at least one example, the latitude and longitude of the geolocational movements are filtered based on the set of predetermined coordinates to determine if any are within the detail window. Further to the example, this allows for processing resources to be saved, providing increased efficiency.

In another step, a reference point closest to the one coordinate from the predetermined set of coordinates within the one or more detail windows 1404 is determined. The set of geolocational movements are filtered to determine which of the geolocational movements are within the one or more detail windows. In at least one example, each of the geolocational movements within the one or more detail windows are analyzed to determine which of the geolocational movements within the one or more detail windows are closest to the predetermined coordinate within the one or more detail windows. The one or more detail windows may be found surrounding the predetermined coordinate. In some examples, there may two or more detail windows on two or more sides of the predetermined coordinate allowing for directional movement to be determined as well as position and timing. The position and timing, may also allow for a determination of the approximate timing of when the predetermined coordinate is passed or approached by a user. A ratio may be created to allow for the determination of the timing, position, or direction of a reference point closest to the predetermined coordinate. Each reference point can be found through the analysis.

Additional examples of this step could include, analyzing each of the geolocational movements that have been recorded to determine if any of them are within one or more of the detail windows. If the any of the geolocational movement are determined to be within one or more of the detail windows during the analysis, then calculate the distance from the geolocational movement to the predetermined coordinate that may be a trigger point. The calculations can be repeated until the minimum or closest distance to the predetermined coordinate within the one or more detail windows is found, and saved as a reference point. There can be multiple references point that create a set of reference points.

In another step, the set of geolocational movements of the user is divided into one or more subgroups based on the reference points 1405. The set of geolocational movements can be divided into laps, or stages to allow for specific stages or laps to be timed. For example, the first and last points within the lap or stage can be utilized to calculate time difference between these two points. Each lap or stage can be viewed as a subgroup of the set of geolocational movements. If in a closed course example, there may be multiple reference points within the same detail window separated by a number of other recorded geolocational movements before another point is found to be within the detail window. This would be an example of a possible lap, that is then saved as a subgroup once two reference points are found.

In another step, the one or more subgroups are analyzed to determine if a threshold number of each set of geolocational movement within the subgroup are within a detection area around each of the predetermined set of coordinates 1406. Each subgroup can include a number of geolocational movements that can be filtered and/or compared with the set of predetermined coordinates. For example, the subgroup may be a bucket or set of buckets that include a selected number of geographical movements. Each bucket, in at least one embodiment, would be associated with one or more predetermined coordinates, with the predetermined coordinates each having a detection area around the predetermined coordinate. Each subgroup or bucket can be filtered with geographical coordinates that equate to the detection area around a predetermined coordinate, and if one or more of the geolocational movements are within the detection area, then the checkpoint (a predetermined coordinate or reference point) is authenticated as being achieved.

In another step, the subgroup is authenticated if the threshold number of each subgroup is achieved 1407. Each subgroup or bucket may have a threshold number of points that must be authenticated to allow for the subgroup or bucket to be authenticated. For example, the threshold value may be 80%, 90%, 95% or any desired percentage value. For a lap or stage to be authenticated, a lap or stage threshold number of subgroups or buckets must also be achieved. If the threshold values are achieved then the lap or stage is authenticated, allowing for timing values to be calculated and saved for transmission to a database or client terminal. Accordingly, a user may not follow the path created and defined as the set of predetermined coordinates, for the entire course and not have a subgroup, bucket, lap, or stage authenticated. However, a user may have a small number of predetermined coordinates that are not authenticated but yet still achieve the threshold value for a subgroup, bucket, lap, or stage then the subgroup, bucket, lap, or stage and is thereby authenticated.

Additional examples of this step could include analyzing each of the subgroups to determine if one or more of the geolocational movements fall within one or more detection areas that surround one or more predetermined coordinate or check point. For example, point 22 may fall within a detection area for predetermined coordinate or check point 3, while point 23 does not fall within a detection area. In at least one example, any predetermined coordinates between reference points are check points. If a geolocational movement falls within a detection area for a check point then that check point is authenticated for that lap or stage. Similar to the reference points, if there are a number of geolocational movements between a second or additional entry within a detection area then the checkpoint may have a second or additional authentications. If there are enough authenticated checkpoints (e.g., above a threshold number) for a subgroup, it is considered authenticated, allowing a lap or stage, or a portion thereof to be authenticated as well. These authenticated laps or stages can then be used to determine approved or authenticated results.

In another step, calculating a timing difference between the first geolocational movement and the last geolocational movement within the subgroup or bucket 1408. Once a lap, stage, subgroup, or bucket is authenticated, its timing values can be calculated as the difference between the recorded time for the last point and the first point of the lap, stage, subgroup, or bucket. If the timing value is for a subgroup, or bucket, a lap or stage timing value can be calculated as the summation of the timing values for the subgroups or buckets within the lap or stage.

In another step, the subgroups that were authenticated can be aggregated into a list 1409. The timing values for a lap, stage, subgroup, or bucket can be aggregated to generate a list of timing values. The list of timing values can include both the times calculated for the user, as well as other users that have their timing value lists from one or more databases.

In another step, the list is displayed on the at least one client terminal 1410. The list of timing values can be visually displayed to the user through the at least one client terminal. In at least one example, the list of timing values may include the timing value lists for other users, in an ordered manner. Further to this example, the list may be ranked or weighted based on characteristics of the user or a user's vehicle or other method of transportation.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to (a) information permanently stored on non-writeable storage media (e.g., read only memory devices within a computer such as ROMs or CD-ROM disks readable only by a computer I/O attachment); (b) information alterably stored on writeable storage media (e.g., floppy disks and hard drives); or (c) information conveyed to a computer through communication media, such as a local area network, a telephone network, a public network like the Internet. It should be understood, therefore, that such media, when carrying computer readable instructions that direct the method functions of the present invention, represent alternate embodiments of the present invention.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than recited unless the particular claim expressly states otherwise.

### Additional Description

The following paragraphs are offered as further description of the various embodiments disclosed invention.

In a first embodiment, novel aspects of the present disclosure describe a computer-implemented method for tracking a vehicle's course using geolocation data, the method comprising: obtaining, from a central database, a set of predetermined location positions representing a closed course; tracking movements of a user using a location determination controller, where tracking the movements of the user further comprises timing the movements of the user; authenticating the movements of the user against the set of predetermined location positions while the client terminal is within a predetermined distance of at least one of the set of predetermined location positions; upon determining whether successful authentication of the user's movements is greater than a predetermined success threshold, storing timing information in the central database, and retrieving and presenting the timing information on the client terminal.

In another aspect of the first embodiment, novel aspects of the present disclosure describe a computer-implemented method for tracking a vehicle's course using geolocation data, the method comprising: obtaining, from a central database, a set of predetermined location positions representing a closed course; tracking movements of a user using a location determination controller, where tracking the movements of the user further comprises timing the movements of the user; authenticating the movements of the user against the set of predetermined location positions while the client terminal is within a predetermined distance of at least one of the set of predetermined location positions; upon determining whether successful authentication of the user's movements is greater than a predetermined success threshold, storing timing information in the central database, and retrieving and presenting the timing information on the client terminal; and one or more limitations selected from the following list:

wherein tracking the movements of the user employs at least one of GPS technology, Assisted GPS technology (AGPS), Differential GPS (DGPS) technology, Time of Arrival (TOA) technology, Enhanced Time of Arrival technology, Maximum Likelihood and Least-Square location techniques, Angle of Arrival location technique, Received Signal Strength localization, Single Fingerprinting, WIFI, and RFID technology;

wherein the predetermined distance is 8 meters;

wherein the method further comprises: aggregating the timing information of a plurality of users into an ordered list and presenting the ordered list to the plurality of users on the graphical user interface on the client terminal;

wherein successful authentication comprises authentication of the predetermined number of the set of predetermined location positions;

wherein the set of predetermined location positions comprises GPS locations;

wherein the set of predetermined location positions comprises a sequence of predetermined location positions;

wherein the method further comprises: tracking a second user's geolocation positions at predetermined intervals to generate the set of predetermined location positions; and uploading the set of predetermined GPS locations to the central database;

wherein the predetermined success threshold is defined by ongoing aggregation and normalization of rates of successful authentication;

wherein the predetermined success threshold is 70%;

wherein the predetermined distance is defined by ongoing aggregation and analysis of geolocation information of users;

wherein tracking of the user's movements is activated by a motion sensor;

wherein the set of predetermined location positions are access-restricted.

wherein tracking the user's movements and authenticating the movements of the user starts at any one of the predetermined location positions;

In a second embodiment, novel aspects of the present disclosure describe a system for tracking a vehicle's course using geolocation data, the system comprising: a central processing server in communication with a computer network and configured to obtain information from a central database; one or more client terminals in communication with the central processing server via the computer network, and configured to provide a graphical user interface for user interaction with the central processing server; wherein the one or more client terminals is configured to: obtain, from the central database, a set of predetermined location positions representing a closed course; track movements of a user using a location determination controller, where tracking the movements of the user further comprises timing the movements of the user; authenticate the movements of the user against the set of predetermined location positions while the client terminal is within a predetermined distance of at least one of the set of predetermined location positions; and upon determining whether successful authentication of the user's movements is greater than a predetermined success threshold, storing timing information in the central database, and retrieving and presenting the timing information on the client terminal.

In another aspect of second embodiment, novel aspects of the present disclosure describe a system for tracking a vehicle's course using geolocation data, the system comprising: a central processing server in communication with a computer network and configured to obtain information from a central database; one or more client terminals in communication with the central processing server via the computer network, and configured to provide a graphical user interface for user interaction with the central processing server; wherein the one or more client terminals is configured to: obtain, from the central database, a set of predetermined location positions representing a closed course; track movements of a user using a location determination controller, where tracking the movements of the user further comprises timing the movements of the user; authenticate the movements of the user against the set of predetermined location positions while the client terminal is within a predetermined distance of at least one of the set of predetermined location positions; and upon determining whether successful authentication of the user's movements is greater than a predetermined success threshold, storing timing information in the central database, and retrieving and presenting the timing information on the client terminal; and one or more limitations selected from the following list:

wherein the predetermined distance is 8 meters;

wherein the set of predetermined location positions comprises GPS locations;

wherein the set of predetermined location positions comprises a sequence of predetermined location positions;

wherein the one or more client terminals is further configured to aggregate the consolidated timing information of a plurality of users into an ordered list and present the ordered list to the plurality of users;

wherein successful authentication of the predetermined number of the set of predetermined location positions comprises authentication of the predetermined number of the set of predetermined location positions based on the sequential order;

wherein the one or more terminals is further configured to track the user's geolocation coordinates at predetermined intervals to generate the set of predetermined location positions; and upload the set of predetermined location positions coordinates to the central database;

wherein the predetermined success threshold is defined by ongoing aggregation and normalization of rates of successful authentication;

wherein the predetermined distance is defined by ongoing aggregation and analysis of GPS location information of users;

wherein tracking of the user's movements is activated by a motion sensor;

wherein the set of predetermined location positions locations are access-restricted;

wherein the tracking the user's movements and authenticating the movements of the user starts at any one of the predetermined location positions;

wherein tracking the movements of the user employs at least one of GPS technology, Assisted GPS technology (AGPS), Differential GPS (DGPS) technology, Time of Arrival (TOA) technology, Enhanced Time of Arrival technology, Maximum Likelihood and Least-Square location techniques, Angle of Arrival location technique, Received Signal Strength localization, Single Fingerprinting, WIFI, and RFID technology; and

wherein the predetermined success threshold is 70%.

In a third embodiment, novel aspects of the present disclosure describe a closed-course generation system used with a tracking system for tracking a vehicle's course using geolocation data, the closed course system comprising: a central processing server in communication with a computer network and configured to obtain information from a central database; a mobile device in communication with the central processing server via the computer network, comprises a geolocation controller, and is configured to provide a graphical user interface for user interaction with the central processing server; wherein the mobile device is configured to: track a path using the geolocation controller along the closed course; records geolocation positions of the closed course to a set of predetermined geolocation positions; and stores the set of predetermined geolocation positions to the central database; wherein one or more client terminals of the tracking system accesses the set of predetermined geolocation positions in the central database, tracks movements of users of the one or more client terminals, authenticates the movements of the users against the set of predetermined geolocation positions while the one or more client terminals is within a predetermined distance of at least one of the set of predetermined geolocation positions; and upon determining whether successful authentication of the users' movements is greater than a predetermined success threshold, stores timing information in the central database.

In another aspect of the third embodiment, novel aspects of the present disclosure describe a closed-course generation system used with a tracking system for tracking a vehicle's course using geolocation data, the closed course system comprising: a central processing server in communication with a computer network and configured to obtain information from a central database; a mobile device in communication with the central processing server via the computer network, comprises a geolocation controller, and is configured to provide a graphical user interface for user interaction with the central processing server; wherein the mobile device is configured to: track a path using the geolocation controller along the closed course; records geolocation positions of the closed course to a set of predetermined geolocation positions; and stores the set of predetermined geolocation positions to the central database; wherein one or more client terminals of the tracking system accesses the set of predetermined geolocation positions in the central database, tracks movements of users of the one or more client terminals, authenticates the movements of the users against the set of predetermined geolocation positions while the one or more client terminals is within a predetermined distance of at least one of the set of predetermined geolocation positions; and upon determining whether successful authentication of the users' movements is greater than a predetermined success threshold, stores timing information in the central database, and one or more limitations selected from the following list:

wherein the predetermined distance is 8 meters;

wherein the one or more client terminals is further configured to aggregate the timing information of the users into an ordered list and present the ordered list to the users;

wherein successful authentication comprises authentication of the predetermined number of the set of predetermined location positions;

wherein the set of predetermined location positions comprises GPS locations;

wherein the set of predetermined location positions comprises a sequence of predetermined location positions;

wherein the geolocation positions are 16 meters apart from each other;

wherein the predetermined success threshold is defined by ongoing aggregation and normalization of rates of successful authentication;

wherein the predetermined distance is defined by ongoing aggregation and analysis of GPS location information of users;

wherein the predetermined success threshold is 70%;

wherein the set of predetermined location positions locations are access-restricted;

wherein the tracking the user's movements and authenticating the movements of the user starts at any one of the predetermined location positions;

wherein tracking the movements of the user employs at least one of GPS technology, Assisted GPS technology (AGPS), Differential GPS (DGPS) technology, Time of Arrival (TOA) technology, Enhanced Time of Arrival technology, Maximum Likelihood and Least-Square location techniques, Angle of Arrival location technique, Received Signal Strength localization, Single Fingerprinting, WIFI, and RFID technology; and

wherein the predetermined success threshold is 70%.

In a fourth embodiment, novel aspects of the present disclosure describe a closed-course generation method used with a tracking system for tracking a vehicle's course using geolocation data, the closed course system comprising: tracking a path using the geolocation controller along a closed course; recording geolocation positions of the closed course to a set of predetermined geolocation positions; and storing the set of predetermined geolocation positions to the central database; wherein one or more client terminals of the tracking system accesses the set of predetermined geolocation positions in the central database, tracks movements of users of the one or more client terminals, authenticates the movements of the users against the set of predetermined geolocation positions while the one or more client terminals is within a predetermined distance of at least one of the set of predetermined geolocation positions; and upon determining whether successful authentication of the users' movements is greater than a predetermined success threshold, stores timing information in the central database.

In another aspect of the fourth embodiment, novel aspects of the present disclosure describe a closed-course generation method used with a tracking system for tracking a vehicle's course using geolocation data, the closed course system comprising: tracking a path using the geolocation controller along a closed course; recording geolocation positions of the closed course to a set of predetermined geolocation positions; and storing the set of predetermined geolocation positions to the central database; wherein one or more client terminals of the tracking system accesses the set of predetermined geolocation positions in the central database, tracks movements of users of the one or more client terminals, authenticates the movements of the users against the set of predetermined geolocation positions while the one or more client terminals is within a predetermined distance of at least one of the set of predetermined geolocation positions; and upon determining whether successful authentication of the users' movements is greater than a predetermined success threshold, stores timing information in the central database, and one or more limitations selected from the following list:

wherein the predetermined distance is 8 meters;

wherein the one or more client terminals is further configured to aggregate the timing information of the users into an ordered list and present the ordered list to the users;

wherein successful authentication comprises authentication of the predetermined number of the set of predetermined location positions;

wherein the geolocation positions are 16 meters apart from each other;

wherein the predetermined success threshold is defined by ongoing aggregation and normalization of rates of successful authentication;

wherein the set of predetermined location positions comprises GPS locations;

wherein the set of predetermined location positions comprises a sequence of predetermined location positions;

wherein the predetermined distance is defined by ongoing aggregation and analysis of GPS location information of users;

wherein the predetermined success threshold is 70%;

wherein the set of predetermined location positions locations are access-restricted;

wherein the tracking the user's movements and authenticating the movements of the user starts at any one of the predetermined location position;

wherein tracking the movements of the user employs at least one of GPS technology, Assisted GPS technology (AGPS), Differential GPS (DGPS) technology, Time of Arrival (TOA) technology, Enhanced Time of Arrival technology, Maximum Likelihood and Least-Square location techniques, Angle of Arrival location technique, Received Signal Strength localization, Single Fingerprinting, WIFI, and RFID technology; and

wherein the predetermined success threshold is 70%.

We claim:

1. A system for detection of progress along a course comprising:
at least one server in communication with a computer network and configured to obtain information from at least one database;
at least one client terminal in communication with the computer network and configured to provide a graphical user interface for user interaction with the at least one server;
at least one predetermined set of coordinates obtained from the at least one database by the at least one client terminals;
wherein the at least one predetermined set of coordinates includes at least one trigger point, and at least one check point;
wherein each of the at least one check point has a detection area to establish completion of each of the at least one checkpoint;
wherein each of the at least one trigger point incudes at least one detail window; and
wherein a recorded set of geographical locations is created from a set of specified points or timing along the course with the at least one client terminal.

2. The system of claim 1, wherein the at least one client terminal captures a set of recorded geolocational movements.

3. The system of claim 2, wherein one or more of the set of recorded geolocational movements are within the at least one detail window.

4. The system of claim 2, wherein one or more of the set of recorded geolocational movements are within the detection area of one or more of the at least one check point.

5. The system of claim 2, wherein the set of recorded geolocational movements are captured from a second client terminal device upon which the set of recorded geolocational movements are recorded and stored.

6. The system of claim 1, wherein at least two detail windows are utilized around the at least one trigger point.

7. The system of claim 6, wherein a portion of a set of recorded geolocational movements fall within the at least two detail windows.

8. The system of claim 7, wherein the at least one trigger point is equally surrounded on two sides by the at least two detail windows.

9. The system of claim 8, wherein each of the portion of the set of recorded geolocational movements that fall within the at least two detail windows is measured to find the closest recorded geolocational movement to the at least one trigger point for each detail window.

10. The system of claim 1, wherein if one or more of a set of recorded geolocational movements fall within a detection area for at least one checkpoint that checkpoint is considered complete.

11. A method for detecting progress along a course through geolocation data comprising:
retrieving at least one predetermined set of coordinates via a computer network;
recording a set of geolocational movements of a user;
analyzing each of the geolocational movements to determine if it is within a predetermined distance from one of the set of coordinates;
dividing the set of geolocational movements into at least one subgroup; and
wherein in a subgroup timing value is calculated based on the first and last geolocational movement of each subgroup that is completed.

12. The method of claim 11, wherein each of the at least one predetermined set of coordinates comprises at least one trigger point, and at least one detail window corresponding to each of the at least one trigger point.

13. The method of claim 11, wherein each of the at least one predetermined set of coordinates comprises at least one checkpoint, and at least one detection area for each of the at least one checkpoint.

14. The method of claim 11, wherein each of the geolocational movements within the set includes a plurality of locational vectors or points.

15. The method of claim 11, wherein the one of the set of coordinates comprises at least one detail window, and if the analyzed geolocational movement is within one of the at least one detail window, calculating a distance from the geolocational movement to at least one trigger point associated within the at least one detail window.

16. The method of claim 15, wherein the calculation of the distance to the at least one trigger point is repeated for each of the geolocational movements within the at least one detail window until the minimum distance is found, wherein the geolocational movement corresponding to the minimum distance is saved in a set of reference points, wherein each reference point within the set of reference points corresponds to one of the at least one detail window.

17. The method of claim 16, wherein the first geolocational movement within each of the at least one subgroup corresponds to one of the reference points, and the last geolocational movement within each of the at least one subgroup corresponds to the geolocational movement before the next reference point or the last geolocational movement.

18. The method of claim 11, further comprising analyzing each subgroup to determine if any of said subgroup's geolocational movements fall within the predetermined distance from each of the coordinates within the set of coordinates.

19. The method of claim 18, wherein the predetermined distance corresponds to at least one detection area for each of at least one checkpoint that is equal to one of the coordinates,

20. The method of claim 19, wherein if one or more of said subgroup's geolocational movements fall within the at least one detection area then the checkpoint is completed, if a summation of completed checkpoints are above a predetermined threshold, then the subgroup is considered completed.
